(19) United States
(12) Patent Application Publication
(10) Pub. No.: US 2006/0259922 A1
(43) Pub. Date: Nov. 16, 2006

(54) SIMPLE AUTOMATED POLLING SYSTEM FOR DETERMINING ATTITUDES, BELIEFS AND OPINIONS OF PERSONS

(75) Inventors: Jeffrey Sandgren, Sewell, NJ (US); Cyndi Reitmeyer, Belmont, MA (US); Kelly McLain, Marlton, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Checkpoint Systems, Inc., Thorofare, NJ (US)

(21) Appl. No.: 11/382,795

(22) Filed: May 11, 2006

Related U.S. Application Data
(60) Provisional application No. 60/680,338, filed on May 12, 2005.

(51) Int. Cl. H04N 7/16; H04H 9/00

(52) U.S. Cl. 725/13; 725/9; 725/10

(57) ABSTRACT

An automatic system and method for polling persons for their insights regarding products, services, political or sociological matters. The system and method are provided at or in a venue, wherein persons located at or in the venue are provided with a question that requires a one word response. The system and method automatically records the one word response, without human intervention, and process the responses to provide a database from which significant data can be mined.

### CROSS REFERENCE TO RELATED APPLICATIONS

This application is a replacement of and claims priority from provisional U.S. Patent Application No. 60/680,338, filed on May 12, 2005 entitled SIMPLE AUTOMATED SHOPPER POLLING SYSTEM.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF INVENTION

This invention relates to surveys and more particularly to providing a simple and efficient means of capturing insights of persons in the commercial and other environments.

### BACKGROUND OF THE INVENTION

Many businesses and industries conduct market research for collecting information from consumers to evaluate their attitudes, beliefs and opinions (e.g., “insight”) regarding various products and/or services. Such market research may be conducted in-house or by the use of “data survey” providers to collect and analyze that information. Retail and consumer packaged goods manufactures are continually interested in acquiring consumer insight data. The collection of consumer insight data can be accomplished in many different ways, such as surveys administered through the Internet or by mail, focus groups conducted in-person or over the Internet, interactive voice response telephone surveys, in-depth interviews conducted in-person at a particular venue (e.g., a supermarket) or over the telephone, and other device-based approaches.

Traditional, human-based solutions involve having pollsters engaging consumers with long lists of questions is less than desirable in a commercial environment, such as in a supermarket, etc. In particular, many potential respondents shun this interaction, and the pollsters themselves inevitably learn to apply filtering criteria to increase response rate, which inherently biases the sample set. Surveys involving persons asking the respondents questions can also be costly, slow and flawed resulting from inaccuracies or errors in recording the respondent responses. For example, unless the persons taking the responses are multilingual, responses by respondents in languages and/or dialects other than those readily understood by the persons taking the survey are prone to inaccurate data collection.

Traditional, device-based solutions involve having a kiosk, website, or other electronic device draw consumers to participate. Nevertheless many consumers find this process cumbersome, invasive, and time-consuming, and therefore participation rates are historically poor and the responding population is often not representational of the full targeted population. To avoid this problem respondents may be incentivized with rewards for participation in order to achieve statistically meaningful capture quantities. The subset of individuals with time and inclination to do this process is not representative of the audience mean, so it inherently biases the sample set.

Among various companies provide or have provided survey-taking services and systems are Certified Marketing Services, Inc., SmartRevenue of Ridgefield, Conn., Talking Point Inc. and Websearch.com. Indyme Solutions, Inc. has disclosed a wireless polling type of device, which it called a “guest survey station”, that had several buttons and was designed to gather shopper opinions from shoppers at any location in a retail facility, e.g., on the sales floor, at a checkout counter or at a service counter.

Notwithstanding the foregoing, there remains a need for an automatic system and method for polling persons regarding their insights relating to matters involving products and/or services, politic issues and sociological matters.

All references cited herein are incorporated by reference in their entireties.

### DESCRIPTION OF THE INVENTION

In accordance with one aspect of this invention a method of capturing insights of persons relevant to products, services, political or sociological matters is provided. For applications involving consumer insights into products or services, the method basically comprises the steps of providing at least one question to a consumer located in a venue, such as a commercial environment, by use of an automated display. The display is designed to attract consumers in the vicinity, e.g., has graphics, text, sound, etc. so that they will be respondents. The automated display itself provides a question requiring a single word response from the consumer, e.g., it presents the question visually, audibly, etc. The response, representing the single word, is captured from the consumers by the display, e.g., it may be from an audible response of the consumer, a manual or touch response of the consumer or by the consumer placing a portion of his/her body in proximity to the display. The responses that are captured by the automated display are provided into a database of collected responses and they are aggregated in the database to form characterized data relevant to the products and services. The characterized data is provided to retailers, manufacturers, agencies and any other entity that may have an interest in the characterized data.

In accordance with another aspect of this invention there is provided a system for capturing insights of persons relevant to products, services, political or sociological matters. The system basically comprises an automated display arranged for location in a venue, such as a commercial environment, and provides an attraction to persons, e.g., consumers, within that environment. The automated display may include indicia, text, graphics, sound, animation, etc. and provides a question, which may be presented visually, audibly or visibly and audibly. The question requires a single word response from the consumer. The automated display is arranged for capturing the single word response from each of the consumers, e.g., the display may capture an audible response of the consumer, a manual or touch response of the consumer or by the consumer placing a portion of his/her body in proximity to the display. The automated display provides a plurality of the captured responses into a database of collected responses. The system also includes means for aggregating the responses in the database to form characterized data relevant to the products and services for provision to retailers, manufacturers, agencies and any other entity that may have an interest in the characterized data.

### BRIEF DESCRIPTION OF THE DRAWINGS

The invention will now be described by way of example and reference to the accompanying drawings, in which:

FIG. 1 is a block diagram of one exemplary method of the present invention for presenting persons, such as consumers (and hereinafter referred to as “respondents”), with a question that requires only a single-word answer or response;

FIG. 2 depicts one exemplary method of receiving and interpreting the response of the respondent using a sound transducer, e.g., microphone and speech recognition;

FIG. 3 depicts a second exemplary method of receiving and interpreting the response of the respondent using proximity sensing;

FIG. 4 depicts a third exemplary method of receiving and interpreting the response of the respondent using a manual input sensor;

FIG. 5 depicts an exemplary system that implements the method of the present invention;

FIG. 6 is an exemplary display located at a store entrance for engaging the respondent and presenting the question;

FIG. 7 depicts a sound transducer arrangement at the display, e.g., a microphone, for receiving the single word response from the respondent;

FIG. 8 depicts a manual input sensor arrangement at the display for receiving the simplified response from the respondent; and

FIG. 9 depicts a proximal sensor arrangement at the display for receiving the response from the respondent.

### DETAILED DESCRIPTION OF PREFERRED EMBODIMENTS

The invention will be illustrated in more detail with reference to the following examples, but it should be understood that the present invention is not deemed to be limited thereto.

The invention is directed to providing a simple and efficient means of capturing respondent insights regarding products, services, political or sociological matters. In the particular, exemplary embodiments to follow the insights are of consumers in commercial venues. Thus, in such a case the primary target is shopper insights in the retail environment, e.g., in supermarkets, department stores, shopping malls, etc.; but the invention could also apply to other consumer segments and venues, such as banking customer insights at an ATM machine, etc.

Retailer and consumer packaged goods manufacturers are continually interested in acquiring fresh insights from consumers. Thus, as used hereinafter the term consumer/patron is meant to encompass any respondent whose insights are desired to be explored with respect to products, services, etc. Moreover, the term commercial environment or venue as used herein is meant to encompass not only retail environments such as mentioned above, but also any venue where persons may gather, other than in their own homes. Examples of such other venues are trade shows, conventions, waiting areas, etc.

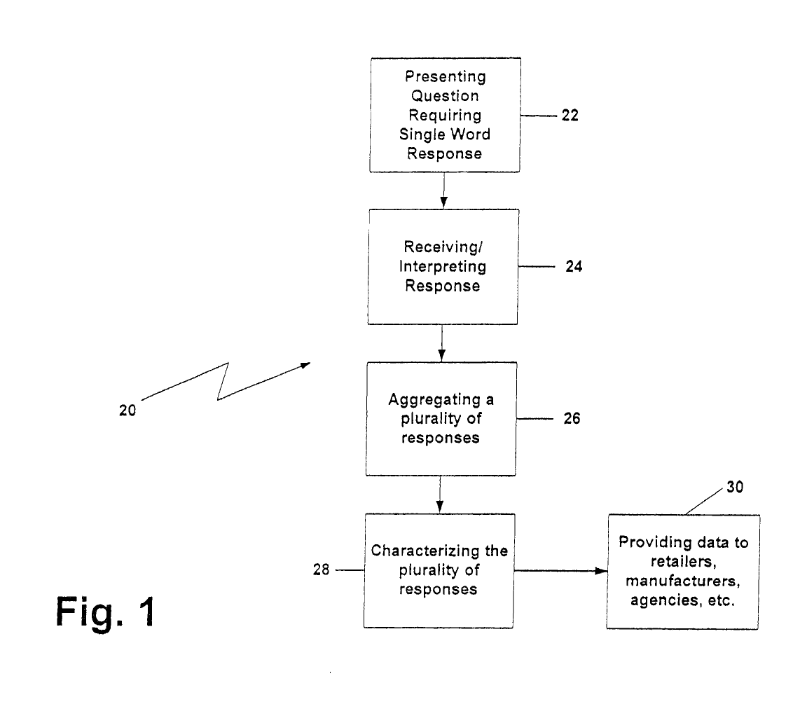

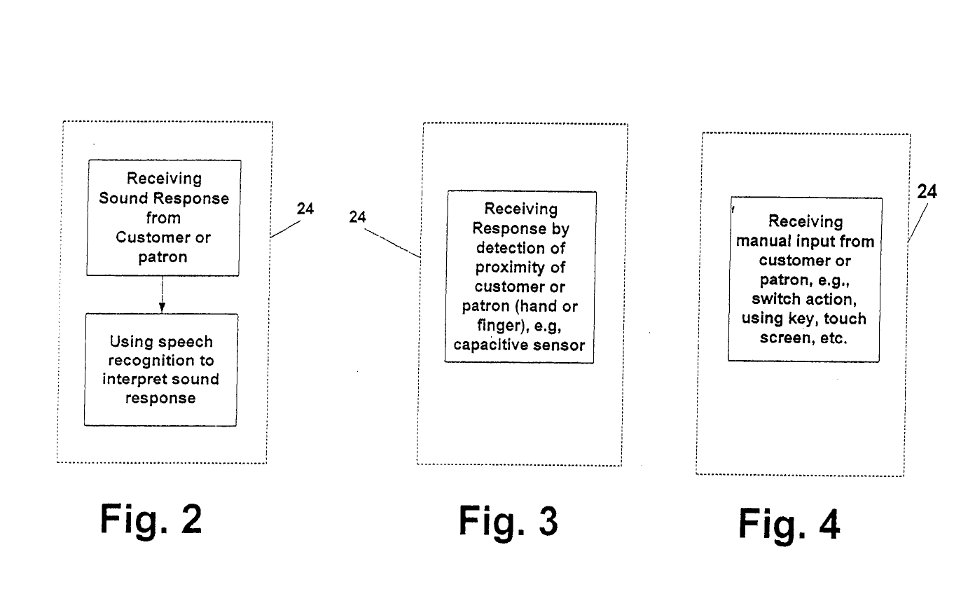

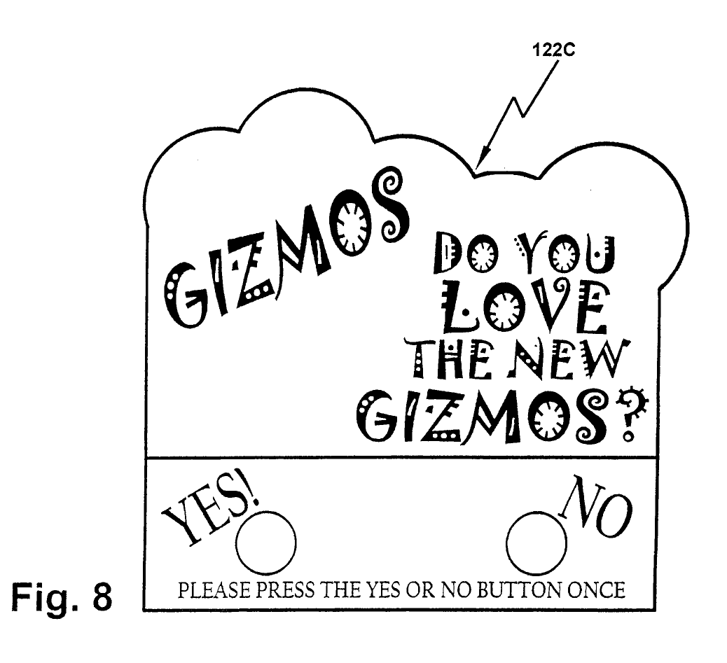

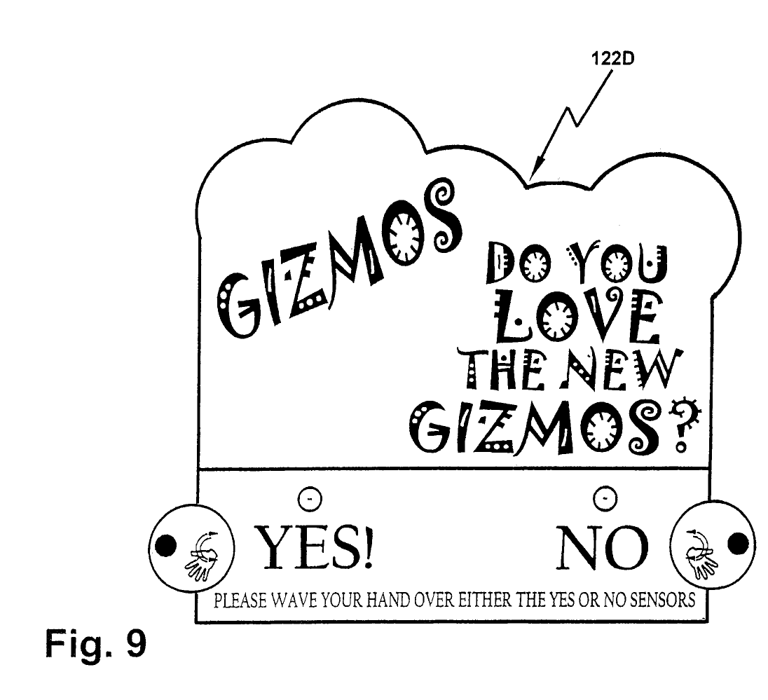

As best seen in FIG. 1, the method 20 of the present invention basically entails presenting consumer/patrons in a commercial environment with a simple question requiring only a single-word response, e.g., a “yes” or “no” as shown by block 22. The question presented will be dependent upon the subject matter of the study, the data desired to be collected and analyzed and the purpose of the analysis. Thus, the question can be tailored or designed to enable the responses to be collected for analysis to provide marketing or other information relevant to a product, service, etc. Unlike many consumer surveys taken in commercial environments, wherein the consumers are presented with one or more questions by survey taking personnel, the question of this invention does not require a person to present it. Thus, in accordance with one aspect of this invention the question can be presented visually by means of a static display, e.g., by signage, by point-of-purchase advertising means, by a video monitor, etc. For example, in FIGS. 8 and 9, to be described later, the question 22 is shown presented by means of signage or point-or-purchase advertising display. If desired, the question may be presented visually in a dynamic manner, e.g., by moving images appearing on a video display terminal, television, etc. For visually impaired individuals the question may be presented tactilely, e.g., through Braille. The question can also be presented audibly, either alone or in combination with a visual display. Thus for example, the question may be presented to the consumers via a speaker system which may form a portion of a display kiosk, signage, point-of-purchase advertising means, etc.

After being presented with the question the consumer/patron provides his/her response which is captured and interpreted as shown by the block 24. As will be described later the response can be provided by the consumer/patron in various manners, e.g., audibly, tactilely even by proximity detection. The captured responses are then aggregated as shown by block 26 and characterized as shown by block 28. The results are then provided to research resources for retailer, manufacturers, agencies, etc., as shown by block 30.

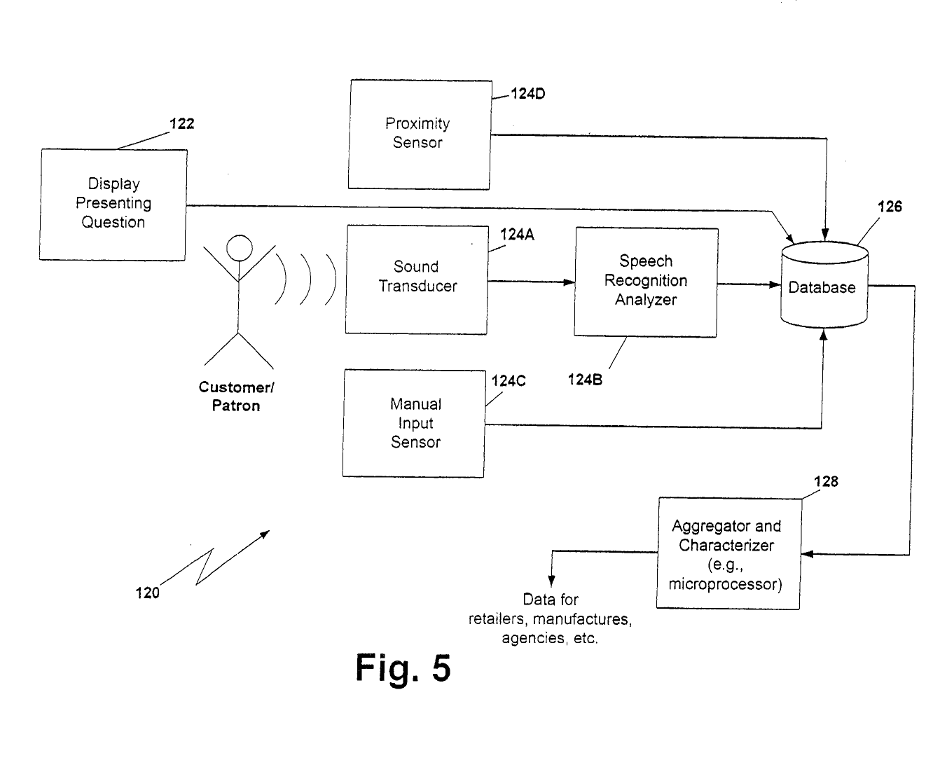

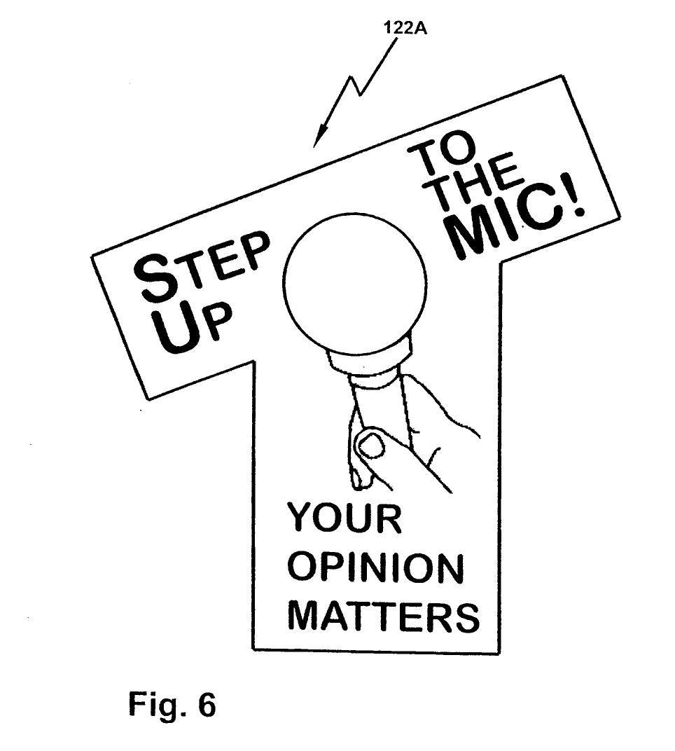

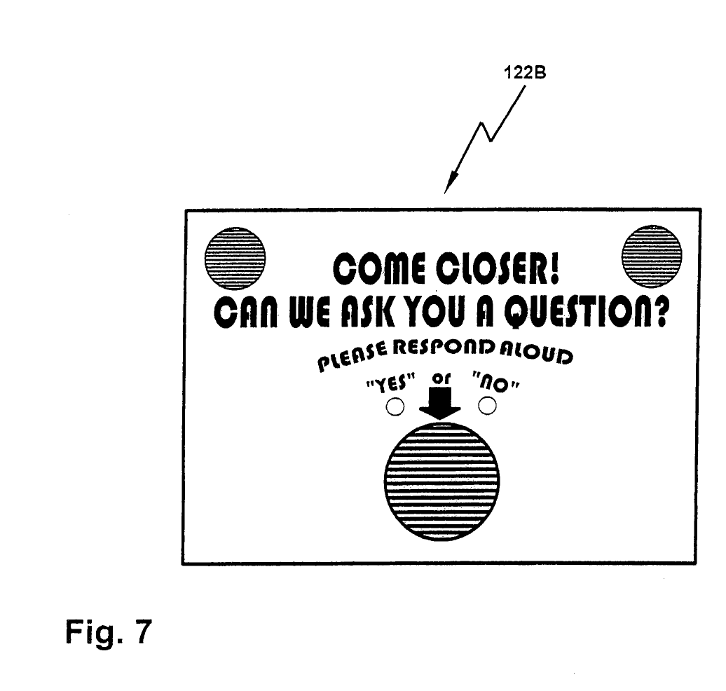

FIG. 5 provides an exemplary system 120 that implements the methods 20 of the present invention. The system 120 comprises a display 122 located at any desired location in the commercial environment, e.g., at the entrance to a store, which is accessible to customers/patrons. The display 122 is arranged to present the question shown in block 22 of FIG. 1. As mentioned above the display can take various forms. For example, in FIGS. 6-7 the question is provided audibly. To that end, in FIG. 6 an exemplary display 122A is shown. That display consists of a panel bearing indicia, in this case the words “Step Up To The Mic” (microphone) and “Your Opinion Matters” and a graphic representation of a microphone. A sound transducer, e.g., tape player, CD player, etc. (not shown) is located at or adjacent the display to provide the question audibly to the person stepping up to the display when actuated. To that end, the display may include a proximity sensor (not shown) to determine when a person has “stepped up” to the microphone, at which time the display provides a pre-recorded message constituting the question for the respondent to hear. Alternatively, the display may include a touch sensor (not shown) or some other manually operated device, e.g., a floor pad switch, which actuates the sound transducer to audibly present the question. In order to receive the one-word response a microphone or other sound transducer 124B (FIG. 5) is provided at the display. The sound transducer 124B is coupled to a speech recognition analyzer 124B. Thus, when a person responds to the question with the appropriate sound bite response representative of the appropriate one word answer, e.g., “yes” or “no”, the sound bite is received by the microphone, converted into an electrical signal which is provided to the speech recognition analyzer 124B. The speech recognition analyzer 124B interprets the sound-bite with using single or multilingual speech recognition technology to determine its content, e.g., whether the person responded with a “yes” or a “no.” (or any other appropriate one-word response). The output of the speech recognition analyzer 124B is provided as data input into a database 126.

In FIG. 7, another display 124B is shown for presenting the question audibly and capturing the response audibly. In this exemplary embodiment the display consists of a panel bearing indicia, in this case the words “Come Closer! Can we ask you a question? Please respond aloud Yes or No” and a graphical representation of an arrow pointing downward to a baffle or grill in the display panel. A pair of speakers (not shown) are located behind respective baffles or grills in the upper right and left corners of the display panel. The speakers are coupled to a sound transducer, e.g., tape player, CD player, etc. (not shown) that is arranged to provide the question audibly to the person stepping up to the display when actuated. To that end, the display may include a proximity sensor (not shown) to determine when a person is at the display ready to receive the question, at which time the pre-recorded message constituting the question is played for the person to hear. Alternatively, the display may include a touch sensor (not shown) or some other manually operated device, e.g., a floor pad switch, which actuates the sound transducer to audibly present the question. In order to receive the one-word response a microphone or other sound transducer 124B (FIG. 5) is provided in the display and is located behind the baffle or grill in the panel to which the graphics of the downward pointed arrow is directed. The sound transducer 124B is coupled to a speech recognition analyzer 124B. Thus, when a person responds to the question with the appropriate one word response, e.g., “yes” or “no”, that audible response is received by the microphone, converted into an electrical signal, which is provided to the speech recognition analyzer 124B, which analyzes the signal to determine its content, e.g., whether the person responded with a “yes” or a “no.” The output of the speech recognition analyzer is provided as data input into a database 126.

It should be noted that the subject invention contemplates that the question can be presented on a continuous basis whether or not a persons is at the display. With such an arrangement, the system 120 may be configured to automatically detect when a person speaks into the microphone of the display, whereupon that person's audible response is picked up by the microphone and the electrical signal produced thereby is processed by the speech recognition analyser to provide an electrical signal indicative of the person's response into the database. In any case, as should be appreciated from the foregoing the system 120 shown in FIG. 5 that makes use of the display 122A shown in FIG. 6 or the display 122B of FIG. 7 permits the consumer/patron response to be entered into the system's database 126 automatically when the person provides an audible response to the question presented.

It should also be pointed out that the person's response need not be an audible response. Thus, as shown in FIG. 5 the system 120 may make use of a manual input sensor 124C, e.g., a button, keypad, touch screen, mouse, motion sensor, etc. For example, as shown clearly in FIG. 8 a display panel 122C is provided for capturing a person's response by means of touch. To that end, the display panel includes a pair of buttons, one for a “Yes” response and one for a “No response.” In the embodiment shown in FIG. 8, the question is not presented audibly, like that in FIGS. 6 and 7, but rather visually. To that end, the display panel includes indicia bearing the question, in this case the words “Gizmos—Do you love the new Gizmos?” In addition the display includes indicia in the form of the words “Yes” and “No” immediately above the corresponding “Yes” and “No” buttons and indicia providing instructions “Please press the yes or no button once.” The display panel 122C may, if desired, have audible means, like that described earlier, to provide the question audibly. Alternatively, the display panel 122C may make use of a static or moving video display of the question, e.g., the question may be presented on a video screen by static or active graphics with or without sound.

FIG. 9 represents another embodiment of a display panel 122D which is similar to the display panel 122C in that it displays the question visually. However, the display panel 122D does not make use of buttons or other devices for a touch response representative of the selected one-word answer. Instead the embodiment of FIG. 9 includes a pair of proximity detectors which enable the user to provide his/her answer by merely waving his/her hand at a predetermined portion of the display panel. In particular, one proximity detector 124D (FIG. 5) is located in the panel adjacent the graphics of a waving hand appearing on the left side of the panel shown in FIG. 9, while another proximity detector 124D is located in the panel adjacent the graphics of a waving hand appearing on the right side of the panel. Each of the proximity sensors can be of any suitable construction, e.g., a capacitive sensor. The sensor is preferably arranged to detect the proximity and movement of the hand or finger of the person.

Irrespective of the construction and arrangement of the display panel, the captured responses are interpreted and then stored in the database 126. The responses can then be aggregated and characterized (e.g., statistical analysis applications can be performed on the aggregated data) using a microprocessor 128. The microprocessor 128 can be located at the venue where the display is located or at some remote location. Once the data is captured, which occurs at the location of the display, and processed or aggregated, which may be accomplished at the location of the display or at some other location within the venue containing the display, the aggregated data will typically be provided to some remote location for analysis and subsequent usage. That action can be accomplished by any suitable means. For example, the data can be uploaded wirelessly or via a telephone modem or cable modem to some remote (master) computer system (not shown) via telephone lines or the Internet. The system may upload the aggregated data automatically at some predetermined time or during any selected time period, or may be remotely polled to upload the information as requested from the remote computer system. Alternatively, the aggregated data can be stored on some type of magnetic media, e.g., a compact flash or SD card, or on an optical disk, e.g., CD, for subsequent usage. Another way of uploading the aggregated data may be to couple the system of this invention to a credit card machine, a point of sale system, an EAS or RFID security system, or any other device or system that is doing other outbound communications.

It should be pointed out at this juncture that while the above description has focused on the data capture and aggregation as occurring within the venue in which the display is located, that arrangement is merely exemplary. Thus, it is contemplated that the data aggregation and analysis functions be accomplished remote from the venue in which the display is located. Accordingly, the systems and methods of this invention are not limited to accomplishing any activity at any particular location, except that the display and the means for collecting the respondent responses must obviously be located at the venue at which the respondents are questioned. The analyzed data produced by the system of this invention can be provided to retailers, manufacturers, agencies, or any other entity interested in the acquired data.

The question presented 122 to the respondent is associated with each response (e.g., see arrow in FIG. 1 between the question presented 122 and the database 126) so that the characterization is properly performed. Moreover, the system of the subject invention can be arranged so that the question presented can be changed readily when desired. This can be accomplished locally or remotely, by downloading the appropriate software to the system creating and displaying/stating the question. For instance, the system may be set up to include a video monitor that displays the question in response to signals from an associated controller (not shown). Some time later another question may be presented in response to signals from the controller. Those signals may be pre-stored in the controller, e.g., the controller include memory with a number of questions saved therein (e.g., queued-up for display at predetermined times or upon some instruction either manually entered or downloaded from some remote computer). Alternatively, the question may be downloaded from some remote source for display upon command from the controller.

The system 120 includes providing an identifier for each question that is either pre-stored in the system or downloaded to the system for presentation (display). That way the answer that is automatically captured is correlated to the question asked. Thus, prior to or in the process of commissioning the system 120, there will be a registration process for registering the questions in the system (if there is more than one question that the system could display at a selected time or times). For example, if the system is to inherently store a number of questions, each for display at a particular time or time period, there has to be first a registration process that identifies each question to be asked, so that when the response is provided to question #18, for example, the answer provided is correlated to question 18 and stored in the system in that manner. In addition, it is also desirable to capture and correlate the date and time for each answer with the answer given. Thus, the system preferably includes some sort of a date and time stamp. It is also preferably, but not mandatory, that the system include an identifier of the location of the display. Thus, in the process of commissioning a store or some other venue with a system 120 of this invention the identification of the store/venue will be stored in the system. By providing the date/time stamp information along with the store identity for each answer, the mining of the collected data can be much richer.

Moreover, as discussed earlier, the system 120 may make use of means for determining when a person is at the location of the display so that the question can be presented to him/her for response. Such means may constitute a pressure sensitive floor pad or switch at the display. Alternatively, infrared (IR) sensors or other proximity sensors can be used. The use of such passive “people sensors” coupled with the fact that the persons responding to the question only have to provide a response indicative of a single word, preserves the anonymity of the respondent. If anonymity of the respondent is not deemed a deterrent to people using the system, the system can be configured to include features that add some user profiling to enhance the richness of the data acquired. For example, if a system uses a pressure sensitive pad to sense a person at the display ready to answer the question, that pad may be coupled to a scale to provide a signal indicative of the person's weight, thereby providing information that may indicate whether the responder is an adult or a child. An IR beam can also be provided to determine the height of the person responding. All of this passively received information can be stored in the system correlated to the answer provided by that person. Thus, a system 120 making use of those techniques is capable of mining significant information from a single word answer, since other information about the person responding is provided automatically without calling for the respondent to provide it. Moreover, if the system is arranged to use voice recognition for determining the one word answer, that software may include sophisticated algorithms for determining the emotional state of the respondent (e.g., whether assertive or “wishy-washy”, harried, pensive, etc.), the sex of the person respondent, and that person's general age, ethnicity or nationality, thereby providing a considerable amount of demographic information passively for storage with the person's response. If privacy or anonymity is not deemed an issue, the system may include means, e.g., the store's surveillance camera or any other camera, for providing an image of the respondent's face, thereby enabling use of sophisticated facial recognition software to glean information, e.g., age, sex, ethnicity, etc. about the person answering the question, which information can be stored with that person response. Use of the system of this invention in conjunction with ATM machines may provide a natural application for acquiring valuable data since such ATM machines are typically equipped with video cameras for securing the image of the person at the ATM machine.

If the system 120 makes use of sophisticated voice recognition software and/or facial recognition software to determine demographic information about the persons answering the questions, such information can be used to calibrate any system of this invention that relies on audible responses to the question to ensure that future audible responses will be correctly interpreted. Thus, it is contemplated that during the initialization or set-up process for a system 120 relying on audibly produced responses, that the software in the system be tuned or trained to local dialects, etc. (e.g., a “Yes” response being in the form of a “Yep” or “Yeh”). Moreover, the software should be trained or configured extract the response over various types of ambient noise that may be expected in the venue in which the display is located, e.g., to tune out background music in a mall setting.

It should be pointed out at this juncture that the system 120 is shown by way of example only and that other arrangements and components can be used to implement the methods 20. In addition, the system 120 may be distributed such that the presented question 122 and the sensor/transducer 124 are located at the display, but the database 126 and microprocessor 128 are remotely-located from the display.

Moreover, as mentioned earlier the system 120 is not limited to use for consumer research. Thus, it can be use for sociological and political research. Irrespective of the type of research to be conducted using the system and methods of this invention, it is believed that audiovisual presentation and its placement are key to achieving high response volumes. Thus, the subject invention provides a viable modality for achieving high response volumes. To further enhance the likelihood of high response volumes the displays can be provided at an desirable location likely to attract respondents to take a moment to answer the question presented, e.g., venue entrance/exit points, adjacent EAS (electronic article surveillance) pedestals, at point of purchase displays, at other promotional displays and other temporary and/or permanent retail fixtures, at point of sale (POS) areas, e.g. checkout and authorization stations, self-checkout stations), at point of queue (e.g. lines before point of sale, pharmacy wait areas, deli wait areas, theater wait areas), at point of service (e.g. at ATMs, kiosks, public telephones, public transportations turnstiles and ticket centers, at vending machines, etc.)

The system of this invention can also be used as an adjunct to or integrated with merchandising solutions. For example, after the system acquires the one word response from the user, if the response is something that is deemed desirable, e.g., a “Yes” response to the question “Do You Love The New Gizmos?” the system may be configured to provide a signal to an associated coupon dispensing machine (not shown) to issue a discount coupon for the next purchase of Gismos. In fact, the system 120 and methods 20 of this invention can serve as a viable means for distributing coupons to persons, rather than just handing out coupons willy-nilly to anybody and everybody that comes by. In this regard, if a display of this invention is located proximate a coupon dispensing machine and is set up to ask if the person would like to have a coupon for Gismos, only persons who respond with a “Yes” answer will be provided with the coupon, thus insuring that the persons to whom the coupons are distributed will likely use them. Moreover, the system will have captured the “No” answers from all those persons who stepped up to the display and answered “No” to the question, thereby providing a means of measuring the level of interest in a particular coupon. Other merchandising advantages of the subject invention can be achieved by means of the system displaying a special code or price for a product or service to the person who answers the question presented in a manner consistent with the granting of the code or price. For example, if the question displayed is “Do You Love The New Gizmos?” the system 120 can be configured so that a person who answers “Yes” will be provided with either a visual and/or audio message saying “Because you love the new Gismos here is a promotional code that if you give to the cashier upon checkout will entitle you to a 10% discount on your Gismos order.” The forgoing examples are but a few of a myriad of examples of how the subject invention can be used in conjunction with promotions, merchandising programs, etc. In addition the subject invention provides adjunct functions that are valuable in traditional survey taking. In this regard, the subject invention may serve as a viable precursor to more expensive and encompassing survey taking. As is known, complex and comprehensive consumer surveys can cost hundreds of thousands, if not millions, of dollars to effectuate, yet the survey may not be appropriate in a particular area. By utilizing the subject invention a simple sampling can be conducted to determine if a more detailed and comprehensive survey should be conducted, e.g., the results of a simple sampling conducted in accordance with this invention may reveal that the basic premise or underpinnings of the more comprehensive study is erroneous, should be directed elsewhere or otherwise needs revision. In that way one could apply a comprehensive survey in the place where the survey taker would get the most yield and the best information from the survey. Another advantage of the subject invention is that it offers survey takers the ability to correlate information gathered from traditional surveys. In this connection, it is a common procedure in survey taking for the survey takers to seek to parlay their hypothesis in their algorithms against some other correlating or cross-checking process. For example, a traditional survey design may hypothecate that X out of Y respondents in a particular geographic area are likely to purchase product A if the price was set below a certain price. The subject invention offers the survey taker a very simple and low cost way of validating that hypothesis. Thus, the subject invention also offers additional roles for use with classic surveys, e.g., in addition to being the whole survey it can have an auxiliary (“prospecting”) role by helping to provide guidance to a survey and/or it can have an additional follow-on role of confirming or cross correlating the results of a traditional survey.

As should be appreciated from the foregoing, the methods 20 and the system 120 of the present invention address the shortcomings of incumbent solutions by extreme simplification of the respondent engagement into an activity that is completely voluntary (i.e., 100% opt-in), completely anonymous (unless participant chooses to identify him/herself), completely hands-free (where the sound transducer is used), completely free of the biases introduced by pollster selections and incentivizations, is non-intrusive on the consumer's time (in the initial implementations the input is gathered while the consumer is performing other activities inherently necessary in the commercial experience, e.g., waiting in lines for checkout, entering and exiting venues, etc.), and is as simple as possible for the consumer to participate (perceive a question, formulate a response, speak a single word). Moreover, the automatic collection of responses achieved by the subject invention is faster than traditional human-based solutions. Further still, the method of this invention is likely to be more accurate and less expensive than existing human-or web-based survey taking methodologies.

Without further elaboration the foregoing will so fully illustrate our invention that others may, by applying current or future knowledge, readily adapt the same for use under various conditions of service.

We Claim:

1. A method of capturing insights of persons relevant to products, services, political or sociological matters, said method comprising the steps of:
providing a question to a person located in or at a venue by use of an automated display in or at the venue, said display providing an attraction to said persons, said question requiring a single word response from the persons;
capturing the single word response from each of the persons by the automated display;
providing a plurality of said captured responses from said automated display into a database of collected responses;
aggregating said responses in said database to form characterized data relevant to said products, services, political or sociological matters; and
providing said characterized data to retailers, manufacturers, agencies and any other entity that may have an interest in the characterized data.

2. The method of claim 1 wherein said single word response is provided audibly in the form of a sound bite by the person.

3. The method of claim 2 wherein said automated display utilizes a sound transducer and speech recognition means to interpret said sound bite to determine the single word response.

4. The method of claim 3 wherein said sound transducer comprises a microphone.

5. The method of claim 1 wherein said single word response is provided by the person by placing a portion of his/her body in proximity to a first input portion of the automated display to establish the single word response.

6. The method of claim 5 wherein said automated display utilizes a proximity sensor at said first input portion of the automated display to detect the proximity of the portion of the person's body with respect thereto.

7. The method of claim 6 wherein said proximity sensor comprises a capacitive sensor.

8. The method of claim 5 wherein said automated display comprises a second input portion, each of said first and second input portions being arranged to have the person place a portion of his/her body in proximity thereto, whereupon each of said first and second input portions establishes a different single word response in response to the proximity of a portion of the person's body with respect thereto.

9. The method of claim 8 wherein said automated display utilizes respective proximity sensors at said first and second input portions.

10. The method of claim 9 wherein each of said proximity sensors comprises a capacitive sensor.

11. The method of claim 1 wherein said single word response is provided by the person touching a first input portion of said automated display to establish the single word response.

12. The method of claim 11 wherein said first input portion comprises a manual input sensor in the form of a button, or keyboard, or mouse or touch screen.

13. The method of claim 11 wherein said automated display includes two input portions, each of said first and second input portions being arranged to have the person touch it, whereupon each of said first and second input portions establishes a different single word response in response to the person touching it.

14. The method of claim 13 wherein each of said first and second input portions comprises a manual input sensor in the form of a button, or keyboard, or mouse or touch screen

15. The method of claim 1 wherein said step of providing said at least one question to the person is achieved visually.

16. The method of claim 1 wherein said step of providing said at least one question to the person is achieved audibly.

17. A system for capturing insights of persons relevant to products, services, political or sociological matters, said system comprising an automated display arranged for location in or at a venue and providing an attraction to persons within or at the venue, said automated display providing a perceptible question thereat, said question requiring a single word response from the persons, said display also being arranged for capturing the single word response from each of the persons and for providing a plurality of said captured responses into a database of collected responses, said system including means for aggregating said responses in said database to form a characterized data relevant to said products, services, political or sociological matters for provision to retailers, manufacturers, agencies and any other entity that may have an interest in the characterized data.

18. The system of claim 17 wherein said single word response is provided audibly in the form of a sound bite by the person and wherein said automated display comprises audible sensing means.

19. The system of claim 18 wherein said audible sensing means comprises a sound transducer and speech recognition analyzer to interpret said single word response.

20. The system of claim 19 wherein said sound transducer comprises a microphone.

21. The system of claim 17 wherein said single word response is provided by the person by placing a portion of his/her body in proximity to a first input portion of said automated display, said automated display comprises a proximity sensor associated with said first input portion and arranged to detect the proximity of a portion of the person's body with respect thereto.

22. The system of claim 21 wherein said proximity sensor comprises a capacitive sensor.

23. The system of claim 17 wherein said automated display comprises a second input portion, each of said first and second input portions being arranged to have the person place a portion of his/her body in proximity thereto, whereupon each of said first and second input portions establishes a different single word response in response to the proximity of a portion of the person's body with respect thereto.

24. The system of claim 23 wherein said automated display utilizes respective proximity sensors associated with said first and second input portions.

25. The system of claim 24 wherein each of said proximity sensors comprises a capacitive sensor.

26. The system of claim 17 wherein said single word response is provided by touch and wherein said automated display comprises a first input portion arranged to be touched by the person.

27. The system of claim 26 wherein said first input portion is a manual input sensor comprising a button, or keyboard, or mouse or touch screen.

28. The system of claim 26 wherein said automated display comprises a second input portion, each of said first and second input portions being arranged to have the person touch it, whereupon each of said first and second input portions establishes a different single word response in response to the person touching it.

29. The system of claim 2 wherein each of said first and second input portions is a manual input sensor comprising a button, or keyboard, or mouse or touch screen.

30. The system of claim 17 wherein said automated display provides said at least one question visually.

31. The system of claim 17 wherein said automated display provides said at least one question audibly.

32. The system of claim 17 wherein said automated display includes means to attract persons to it.

33. The system of claim 32 wherein said means to attract persons comprises visible text and/or graphics.

34. The system of claim 33 wherein said visible text and/or graphics is animated.

35. The system of claim 32 wherein said means to attract persons comprises sound.

36. The system of claim 33 wherein said means to attract persons additionally comprises sound.

37. The system of claim 17 wherein said means for aggregating said responses in said database comprises microprocessor means.
